(19) United States
(12) Patent Application Publication
(10) Pub. No.: US 2026/0127426 A1
(43) Pub. Date: May 7, 2026

(54) FOUNDATIONAL GENERATIVE PRE-TRAINED TRANSFORMER MODEL WITH TIME-PRESERVING ENCODINGS

(71) Applicant: Microsoft Technology Licensing, LLC, Redmond, WA (US)

(72) Inventors: Kun QIU, Fremont, CA (US); Beibei WANG, Cupertino, CA (US); Shubham AGARWAL, Bangalore (IN); Osaid Rehman NASIR, New Delhi (IN)

(21) Appl. No.: 18/934,480

(22) Filed: Nov. 1, 2024

(51) Int. Cl. G06N 3/08; G06N 3/045

(52) U.S. Cl. CPC G06N 3/08; G06N 3/045

(57) ABSTRACT

Aspects of the disclosure include foundational generative pre-trained transformer (GPT) models with time-preserving encodings and methods of using the same. A method includes assigning a token to each activity of a plurality of activities and collecting, for each entity of a plurality of entities, a sequence of activities. Time-preserving encodings are applied to the collected sequences of activities. A training set including sequences of tokens and the time-preserving encodings is created, each sequence of tokens corresponding to a respective sequence of activities for an entity. A foundational GPT model is trained, using the training set, to generate an activity sequence embedding. During training, the positional encodings preserve a relative order of the input sequence of tokens and an amount of time between each input token in the input sequence of tokens.

### INTRODUCTION

The subject disclosure relates to machine learning and artificial intelligence, and specifically to a foundational generative pre-trained transformer (GPT) model with time-preserving encodings for detecting malicious activities in online platforms.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for a foundational generative pre-trained transformer (GPT) model with time-preserving encodings in accordance with one or more embodiments;

FIG. 2 depicts an example transformer-type implementation for a foundational GPT model with time-preserving encodings in accordance with one or more embodiments;

FIG. 3 depicts an example tokenization of activity data with time-preserving tokens to preserve timing between activities in accordance with one or more embodiments;

FIG. 4 depicts an example positional encoding over continuous time to preserve timing between activities in accordance with one or more embodiments;

FIG. 5 depicts a block diagram of a process for leveraging a foundational GPT model with time-preserving encodings at inference to generate labels in accordance with one or more embodiments;

FIG. 6 depicts a block diagram of a computer system in accordance with one or more embodiments; and

FIG. 7 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Online platforms such as connections networks face significant challenges in detecting and preventing malicious or otherwise abusive activities in-network, such as fake accounts, account takeovers, and data scraping. Traditional methods for detecting these activities often rely on manually crafted features and heuristic-based detection architectures which have native limitations in processing long sequences of user activities and understanding complex behavioral patterns in those sequences, limiting their effectiveness in identifying sophisticated abuse tactics.

Recent advancements in artificial intelligence and machine learning offer new opportunities to address these limitations. For example, recurrent neural networks (RNNs) and long short-term memory (LSTM) architectures can be more capable at capturing long-range dependencies and relationships within sequences, enabling a relatively deeper understanding of user behavior over extended timeframes. Unfortunately, these types of solutions require individual model training schemes for each specific use case (e.g., abuse detection, account takeovers, phishing, etc.), which is resource-intensive and time-consuming. There is a need for a more scalable and reusable approach to model user activities for detecting malicious activities in online platforms and connections networks.

This disclosure introduces a foundational generative pre-trained transformer (GPT) model with time-preserving encodings for detecting malicious activities in online platforms. The foundational GPT model described herein differs significantly from conventional large language models (LLMs) in terms of its architecture, training, and application. Conventional LLMs learn to understand and generate human language by processing large corpora of text. Each word or sub-word in the text is converted into a token, and the model learns the relationships and dependencies between these tokens to generate coherent and contextually appropriate text. The positional encodings in these models capture the relative order of words in a sentence, but they do not account for the actual time intervals between words, as the focus is on the syntactic and semantic structure of the language.

In contrast, the foundational GPT model described herein is trained directly on activity sequences rather than on word or sub-word tokens. Specifically, each type of user activity on a network, such as logging in to the network, viewing a profile, or sending a message, is treated as a separate token. The foundational GPT model is trained on these tokens (also referred to as non-text activity tokens, or simply, as activity tokens) to understand the relationships and dependencies between user activities. Notably, unlike text-based LLMs, the foundational GPT model incorporates time-preserving encodings to account for the actual time intervals between activities (or between activity tokens), providing a more accurate, rich representation of user behavior over arbitrarily extended periods, allowing the foundational GPT model to better capture long-term behavioral patterns.

Training the foundational GPT model on activity tokens rather than on text/word tokens enables the foundational GPT model to generate universal embeddings of user activities and next activity predictions that can then be applied across any number of downstream anti-abuse and malicious activity detection systems and applications. For example, the universal activity embeddings generated by the foundational GPT model can be used, concurrently or simultaneously, with abuse models, phishing models, compromised account detection applications, etc., thereby allowing these secondary systems to detect fake accounts, account takeovers, data scraping, etc. Advantageously, the universal activity embeddings can be readily extended to any secondary system which relies on member activities as input without the need of training those individual models to generate embeddings from raw activity sequences. In short, the foundational GPT model does the heavy lifting by providing the universal activity embeddings.

A foundational GPT model that can learn from extensive user activity histories to generate universal embeddings applicable across multiple abuse detection scenarios significantly enhances the performance and efficiency of anti-abuse systems. This approach eliminates the need for manual feature engineering and reduces the development lead time for new abuse detection models, which no longer need to be trained to generate embeddings. Moreover, by leveraging the temporal dynamics of user activities (that is, the actual time between activities rather than merely their relative order), the foundational GPT model described herein can more effectively identify abnormal and malicious behavior, enhancing the performance and efficiency of anti-abuse systems on online platforms.

### Detailed Embodiment

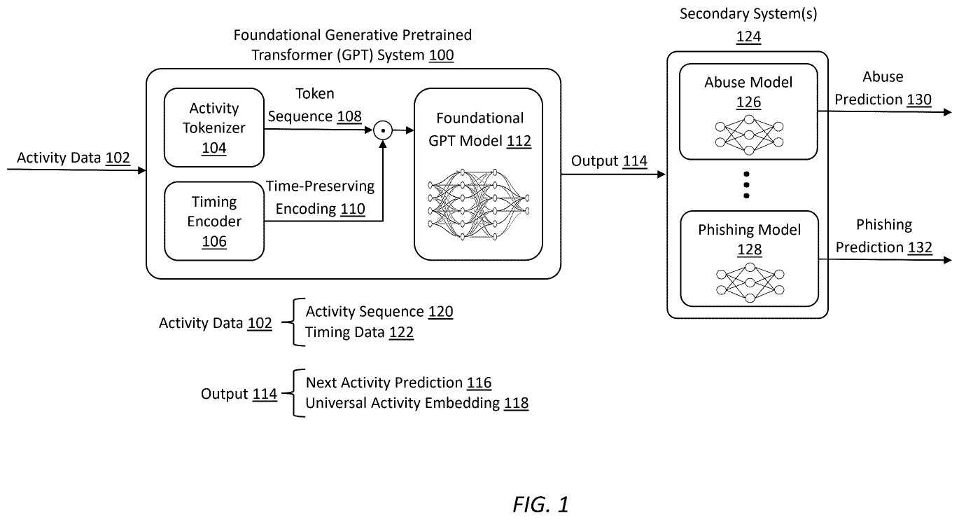

FIG. 1 depicts a block diagram for a foundational generative pre-trained transformer (GPT) system 100 with time-preserving encodings in accordance with one or more embodiments. As shown in FIG. 1, the foundational GPT system 100 processes activity data 102 through an activity tokenizer 104 and a time encoder 106 to generate a token sequence 108 and a time-preserving encoding 110, respectively. These are then combined and input into a foundational GPT model 112, which produces an output 114 that includes a next activity prediction 116 and an activity sequence embedding 118.

Activity data 102 refers to the various actions performed by users on an online platform, such as a connections network, social network, or a professional networking site, and as discussed in greater detail below, are central to understanding user behavior and detecting potential abusive actions. In some embodiments, the activity data 102 is collected and logged by one or more backend systems (not separately indicated) and can include a wide range of user interactions, such as, for example, login and logout events, profile viewing, messaging (sending, receiving, reading, composing, etc.), sending and accepting connection requests, content interactions (liking, commenting, sharing, etc.), job seeking (applying for job(s), searching available/posted jobs, etc.), page viewing (of job listings, company pages, articles, etc.), post creation (status updates, articles, job listings, etc.), group activities and interactions (joining a group, participating in a group discussion, etc.), account setting changes (updating profile information, changing passwords, modifying privacy settings, etc.). These activities are merely illustrative and other activities are possible and within the contemplated scope of this disclosure.

In some embodiments, the activity data 102 includes one or more activity sequences 120 and corresponding timing data 122. An activity sequence 120 in the activity data 102 refers to a chronological (relatively ordered) series of actions performed by a user on the underlying platform or network. In some embodiments, each action, such as logging in, viewing a profile, sending a message, or liking a post, is recorded as an individual activity. For example, consider a user who logs in, views several profiles, sends a few messages, and then logs out. This sequence of activities can be represented as a series of tokens referred to as an activity sequence 120:[login, view profile, view profile, send message, send message, logout]. Thus, activity sequence 120 preserves the relative order of the series of actions performed by a respective user. In some embodiments, activity data 102 is collected for an arbitrarily large number of users of an underlying network (e.g., hundreds, thousands, millions of users, etc.). In some embodiments, each activity sequence in the activity sequences 120 can be coupled to the respective user which generated the specific activity sequence. For example, each activity sequence can be coupled to a user identifier (or account identifier, etc., as desired). In this manner, each specific user's activities can be tracked individually and activity sequences for specific users can be compared against their respective user attributes (e.g., account data, profile data, etc.). Thus, in some embodiments, activity sequences 120 encode the millions of user-specific interactions with content and features presented on a connections network for an arbitrarily large number of users or members.

In some embodiments, the activity sequences 120 are supplemented with corresponding timing data 122 to preserve the absolute (actual) timing between the respective activities. The time intervals between the activities in activity sequence 120 can provide additional information and context for the foundational GPT model 112. In this manner, the foundational GPT model 112 (discussed in greater detail below) can generate richer universal activity embeddings 118. The timing data 122 can include various types of temporal information, such as, for example, timestamp data, time interval data, relative time differences, and/or session durations. Timestamp data can include the exact date and time when each activity occurred. For example, if a user logs in at 10:00 AM, views a profile at 10:05 AM, and sends a message at 10:10 AM, the timestamps for these activities can be recorded. Time interval data can include the duration between consecutive activities. Using the previous example, the time interval between logging in and viewing a profile would be 5 minutes, and the interval between viewing a profile and sending a message would be another 5 minutes, and these values can be recorded. The relative time difference between adjacent activity pairs (that is, an activity and the next occurring activity) can also be recorded. For instance, if a user performs several activities in quick succession, the relative time differences would be small, indicating a burst of activity. Session durations quantify the total duration of a user session, from the time the user logs in to the time they log out, and can help in understanding the overall engagement level and activities of a user over the course of an entire session.

Activity tokenizer 104 converts each of the user activities in the activity data 102 into tokens that the foundational GPT model 112 can process. This process can be referred to as activity tokenization. In some embodiments, the process of tokenization involves assigning a unique identifier to each type of activity. This allows the activity tokenizer 104 to represent complex sequences of user actions in a structured format that can be processed efficiently. For example, in some embodiments, each user activity, such as logging in, viewing a profile, or sending a message, is treated as a distinct token and the process of tokenization involves assigning the corresponding token to each activity of one or more activity sequences 120 in the activity data 102. The resulting sequence of tokens for a respective activity sequence 120 can be referred to as a token sequence 108.

Turning now to the timing encoder 106, observe that, in conventional large language transformers, word token positional encodings capture the relative order of an input sequence of tokens. Notably, the actual elapsed time between successive input tokens is lost (in fact, the positional encodings are constructed by fixing the distance between successive tokens, typically to a unit value of “1”). This intuitively makes sense for human language learning—the expression “I like pizza” spoken rapidly carries the same semantic meaning as the expression “I . . . like . . . pizza” spoken slowly with intermittent pauses of varying lengths, whereas the expression “Pizza I like” is not semantically equivalent to the expression “I like pizza”, however spoken.

To adapt the foundational GPT system 100 to activity understanding, in some embodiments, timing encoder 106 generates time-preserving encodings 110 that encode the time intervals between consecutive tokens (activities) in the token sequence 108. By incorporating time-preserving encodings 110, the foundational GPT model 112 can capture temporal dynamics, providing a more accurate representation of user behavior. In some embodiments, the time-preserving encodings 110 are numerical representations that capture the actual time intervals between activities in an activity sequence 120. In other words, timing encoder 106 supplements the token sequence 108 with time-preserving encodings 110. In this manner, the time-preserving encodings 110 represent the timing data 122 in a manner that the foundational GPT model 112 can process, thereby preserving the absolute timing between activities. Notably, conventional GPTs do not include this type of timing encoder and do not generate absolute time-preserving encodings. Thus, conventional GPTs cannot achieve the same level of activity understanding as is available using the foundational GPT system 100 described herein.

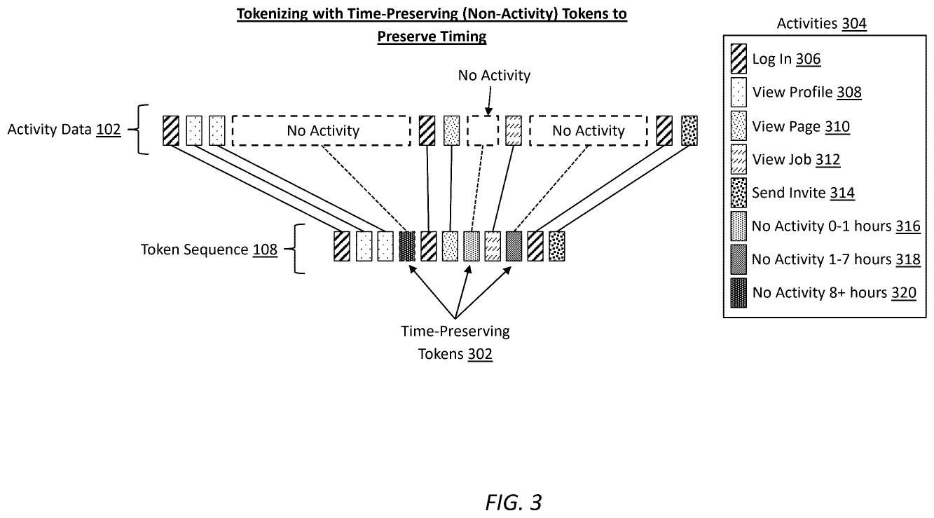

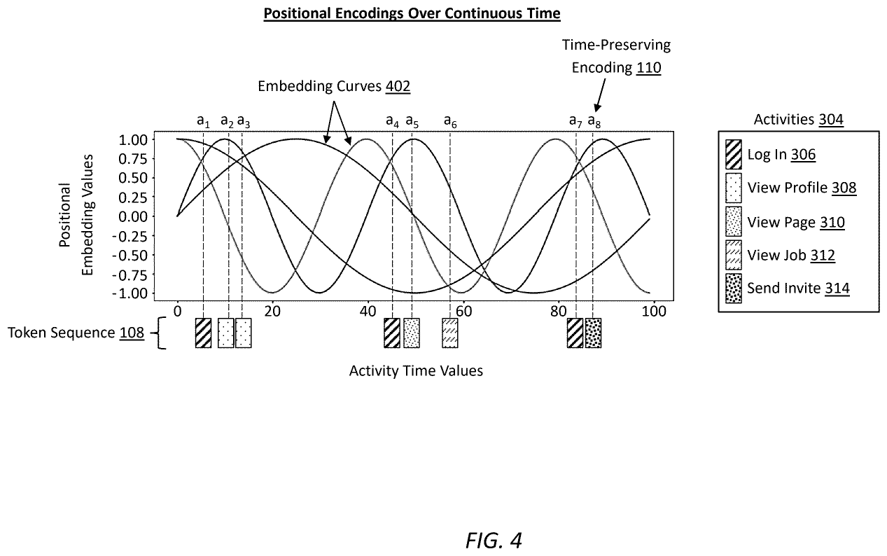

In some embodiments, time-preserving encodings 110 are encoded via time-preserving tokens to preserve the actual timing between activities (refer to FIG. 3). In some embodiments, time-preserving encodings 110 are encoded via positional encodings over a continuous time domain to preserve the actual timing between activities (refer to FIG. 4). In either case, the resulting time-preserving encodings 110 can be combined with the token sequence 108 to form a comprehensive input for the foundational GPT model 112.

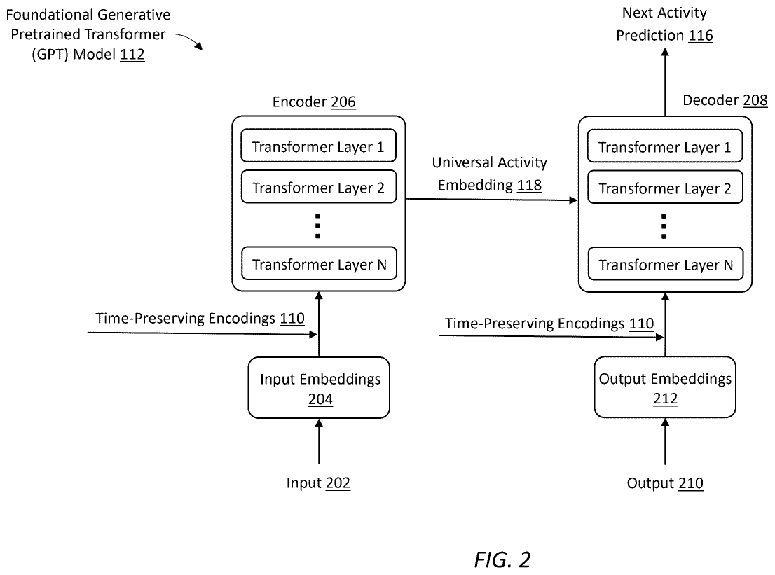

In some embodiments, the foundational GPT model 112 receives this comprehensive input (a combination and/or concatenation of the token sequence 108 and the time-preserving encodings 110) and produces, in response, an output 114 that includes a next activity prediction 116 and an activity sequence embedding 118. In some embodiments, the foundational GPT model 112 is a novel transformer architecture in which conventional positional encodings are replaced and/or supplemented with time-preserving encodings 110. In some embodiments, the foundational GPT model 112 is trained to process tokenized user activities (e.g., token sequence 108) and their corresponding time-preserving encodings 110 to produce the output 114. An example transformer-type architecture for the foundational GPT model 112 is shown in FIG. 2.

Turning now to FIG. 2, in some embodiments, the foundational GPT model 112 is implemented as a transformer-type architecture. As shown in FIG. 2, in some embodiments, the foundational GPT model 112 is trained to process an input 202 consisting of user activities (e.g., activity sequences 120) into input embeddings 204 (e.g., token sequences 108) that can be combined with their corresponding time-preserving encodings 110.

In some embodiments, foundational GPT model 112 includes an encoder 206 and a decoder 208. In some embodiments, encoder 206 is trained to generate universal activity embeddings 118 (refer to FIG. 1), referred to in the context of conventional large language models as encoded representations. While not meant to be particularly limited, encoder 206 can include a neural network machine learning architecture that is capable of processing large amounts of token data and generating high-quality responses. At its core, an encoder takes in a sequence of input tokens (words, sub-words, or characters, activity tokens in the present architecture), and produces a sequence of hidden representations for each token that capture the contextual information of an input sequence. Conversely, decoder 208 then uses these hidden representations (the universal activity embeddings 118), along with a sequence of target tokens, to generate a sequence of output tokens.

In some embodiments, the encoder 206 and decoder 208 are trained to process activity tokens rather than text/word tokens. In particular, in some embodiments, the encoder 206 and decoder 208 are composed of multiple layers of multi-headed self-attention and feedforward neural network layers (collectively, “transformer layers”). The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

The encoder 206 and decoder 208 can be trained on large amounts of tokenized user activity data, such as the activity sequences for millions of users of an underlying connections network. To handle the large amount of activity data, the training process can be highly parallelized. The encoder 206 and decoder 208 can be trained using backpropagation and gradient descent, with the objective of minimizing a loss function such as cross-entropy loss. By training on large numbers of input activity tokens in this manner, the encoder 206 and decoder 208 learn to capture the complex relationships and dependencies between different user actions. This enables the foundational GPT model 112 to generate accurate next activity predictions 116 and rich, universal activity embeddings 118.

As shown in FIG. 2, the transformer-based architecture begins with an input 202 which, as discussed previously, includes an activity sequence 120. Input 202 can be provided by a user or upstream system (not separately indicated) as desired and can be represented as a sequence of tokens (input embeddings 204). In some embodiments, the input embeddings 204 represent the activities within the input 202 as numbers or vectors, which can be processed using encoder 206. In some embodiments, a time-preserving encoding 110 (refer to FIGS. 3 and 4 for additional details) can be generated to encode the relative and absolute position of each token in the input embeddings 204 as a set of numbers. These numbers can be fed into the encoder 206 with the input embeddings 204, allowing the foundational GPT model 112 to more effectively understand both the order and timing of activities and to thereby generate richer, more universal embeddings.

The encoder 206 processes the input embeddings 204 and the time-preserving encodings 110 and generates, for the input 202, an encoded representation (in this implementation, the universal activity embeddings 118) that captures the meaning and context of the input 202. To accomplish this, encoder 206 applies a series of self-attention transformer layers (or simply, “transformer layers”), which are a series of hidden states that represent the input 202 at different levels of abstraction. The encoder 206 can include any number of these transformer layers, as desired. In some embodiments, the universal activity embeddings 118 is provided to decoder 208.

The decoder 208 similarly includes any number of transformer layers, as desired, except that the decoder 208 processes an output 210 rather than input 202. In some embodiments, output 210 is a right-shifted copy of the input 202, meaning that the decoder 208 can only use the previous activity tokens for next-activity prediction. In some embodiments, output embeddings 212 can be generated from the output 210 to represent the tokens in the output 210 as numbers, in a similar manner as described with respect to the encoder 206. A time-preserving encoding 110 can be added to the output embeddings 212 to encode the absolute position of each token in output 210 as a set of numbers. The decoder 208 can be trained by minimizing a loss function (also known as an objective function, which quantifies a difference between a predicted output and a known true value) using, for example, gradient descent, in a similar manner as the encoder 206.

Once trained, the foundational GPT model 112 can be used during an inference phase to generate an output, referred to herein as a next activity prediction 116, which can be thought of as a next-activity probability (that is, how likely is the next activity in a given activity sequence to be activity x, or activity y, etc.). In some configurations, the transformer-based architecture includes a linear layer and SoftMax layer (omitted for clarity) to transform a raw output from the decoder 208 into the next activity prediction 116. For example, after the decoder 208 produces a raw output (e.g., output embeddings), the linear layer can map the output embeddings to a higher-dimensional space, thereby transforming the output embeddings into a same original input space as the input 202. The SoftMax function can be used to generate a probability distribution for each output token in the vocabulary, enabling the foundational GPT model 112 to generate output tokens with probabilities (e.g., the next activity prediction 116).

Returning now to FIG. 1, the output 114 from the foundational GPT model 112 and/or foundational GPT system 100 can be provided to one or more secondary systems 124. The secondary systems 124 are not meant to be particularly limited, but generally include downstream specialized models, systems, applications, and components that process the output 114 generated by the foundational GPT system 100 to perform specific tasks or functions. The secondary systems 124 can utilize one or both of the next activity prediction 116 and the universal activity embedding 118, depending on the needs of a given application. These applications can range from security and abuse detection to user experience enhancement and the generation and/or selection of personalized recommendations. By leveraging the rich, time-preserving context encoded within the universal activity embedding 118, secondary systems 124 can achieve higher accuracy and effectiveness in their respective domains without spending the considerable time and compute costs associated with separately encoding activity sequences. Example secondary systems 124 include abuse models 126 and phishing models 128, although other systems, such as scraping detection systems, compromised account detection systems, recommendation systems, and user experience enhancement systems are possible and within the contemplated scope of this disclosure.

In some embodiments, abuse model 126 is designed to identify and mitigate abusive activities on the underlying platform or network. In some embodiments, abuse model 126 is trained on universal activity embeddings 118 and/or next activity predictions 116 to identify activity patterns indicative of fake accounts, account takeovers, and/or other malicious behaviors. For example, abuse model 126 can be trained on universal activity embeddings 118 to detect user accounts that exhibit suspicious login patterns or unusual messaging behavior. In some embodiments, abuse model 126 can generate an abuse prediction 130 indicating a probability that an input universal activity embedding 118 encodes malicious/abusive account behavior. In some embodiments, abuse model 126 can shut down, suspend, block, reset, or otherwise take action against an account associated with an activity sequence 120 having a probability of malicious/abusive account behavior that is greater than a predetermined threshold.

In some embodiments, phishing model 128 is designed to identify and mitigate phishing attempts on the underlying platform or network. In some embodiments, phishing model 128 is trained on universal activity embeddings 118 and/or next activity predictions 116 to identify activity patterns indicative of phishing attempts. For example, phishing model 128 can be trained on universal activity embeddings 118 to detect user accounts that exhibit patterns of phishing behavior, such as sending a high volume of messages with malicious links. In some embodiments, phishing model 128 can generate a phishing prediction 132 indicating a probability that an input universal activity embedding 118 encodes phishing-type account behavior. In some embodiments, phishing model 128 can shut down, suspend, block, reset, or otherwise take action against an account associated with an activity sequence 120 having a probability of phishing behavior that is greater than a predetermined threshold. In some embodiments, phishing model 128 can modify, delete, or otherwise take action against a link(s) in a message(s) sent from an account associated with an activity sequence 120 having a probability of phishing behavior that is greater than a predetermined threshold.

Scraping detection systems can be designed to identify and block automated data extraction activities. By analyzing the universal activity embeddings 118 and next activity predictions 116, these systems can detect patterns indicative of scraping, such as rapid, repetitive profile views or page accesses. The temporal dynamics captured by the foundational GPT system 100 enable scraping detection systems to differentiate between normal user behavior and automated scraping activities.

Compromised account detection systems focus on identifying accounts that have been compromised, possibly to be used for malicious purposes. By processing the universal activity embeddings 118 and next activity predictions 116, compromised account detection systems can detect unusual activity sequences that deviate from a user's typical behavior. For example, an account that suddenly starts sending a large number of connection requests or messages might be flagged as compromised.

Beyond security applications, the universal activity embeddings 118 and next activity predictions 116 from the foundational GPT system 100 can also enhance recommendation systems. By understanding activity sequences, and therefore user behavior, in a more nuanced way, recommendation systems can provide more personalized and relevant content to users. For example, a job recommendation system might use the universal activity embeddings 118 and next activity predictions 116 to suggest job listings that align with a user's recent activity patterns even before the user starts taking typical job-seeking actions (due, e.g., to a next activity prediction 116 indicating job-seeking activities).

Advantageously, the secondary systems 124 can leverage the rich, time-preserving context encoded within the universal activity embedding 118 and next activity prediction 118 to detect malicious network activity that might be missed when looking solely at the activity sequences 120 and/or in clearing normal activity that might be indicated as malicious when considering the activity sequences 120 alone (that is, without time-preserving encoding 110). For instance, consider a scenario in which a first user uses a first account to view 30 profiles over the course of several hours (normal viewing behavior) and a second user uses a second account to view 30 profiles within a few seconds of logging in (a potential scraping attack). The activity sequences 120 will be equivalent, but the timing data 122 will not. Consequently, a conventional system trained only on activity sequences might indicate both the first user account and the second user account as malicious accounts with scrapping behavior, while the secondary systems 124 described herein can accurately designate the first user account as a normal account, and the second user account as a scrapping account.

FIG. 3 depicts an example tokenization of activity data with time-preserving tokens (also referred to as non-activity tokens or as absolute time-preserving tokens) to preserve timing between activities in accordance with one or more embodiments. As discussed previously, time encoder 106 can build a time-preserving encoding 110 from the activity data 102 and timing data 122. In some embodiments, the time-preserving encodings 110 are encoded as time-preserving tokens 302 that preserve absolute timings between activities 304 in the activity data 102. Activities 304 are not meant to be particularly limited and refer to the interactions and/or actions taken by individuals on an underlying connections network or platform. Activities 304 can encompass a wide range of behaviors and engagements that members or users perform while using a network's features and services. Activities 304 can include, for example, content creation (e.g., posting status updates, photos, or videos, writing comments or replies, sharing links or articles, etc.), social interactions (e.g., liking or reacting to posts, sending friend requests or following other users, joining groups or communities, etc.), profile management (e.g., updating personal information, changing profile pictures or cover photos, adjusting privacy settings, etc.), platform navigation (e.g., logging in and out of the platform, browsing through news feeds or timelines, searching for other users or content, etc.), engagement with content and/or features (e.g., using messaging or chat functions, participating in polls or surveys, engaging with sponsored content or advertisements, etc.). In contrast, time-preserving tokens 302, rather than being activities themselves, represent an amount of time between activities 304.

To illustrate, consider an example scenario in which possible activities 304 include log in 306, view profile 308, view page 310, view job 312, and send invite 314. Of course, these specific activities 304 are merely illustrative. In a full-scale connections network activities 304 can encompass millions of activities presented to and/or interacted with millions of users. In some embodiments, the activities 304 are supplemented with one or more time-preserving tokens 302, such as for “No Activity 0-1 hours” 316, “No Activity 1-7 hours” 318, and “No Activity 8+ hours” 320. The example time-preserving tokens 302 are merely illustrative and are not meant to be particularly limited. The time-preserving tokens 302 can be defined according to any desired intervals of time (e.g., on the order of a few seconds, minutes, hours, days, weeks, months, quarters, years, etc.). In some embodiments, the time-preserving tokens 302 can partially overlap.

As further shown in FIG. 3, the time-preserving tokens 302 can be inserted among the tokens of the token sequence 108 generated by the activity tokenizer 104 (refer to FIG. 1), thereby preserving the absolute timing between the tokens and the activities encoded by those tokens. The token sequence 108, supplemented with the time-preserving tokens 302, can then be passed to the foundational GPT model 112 as discussed previously. Notably, preserving the absolute timing between activities allows for the foundational GPT model 112 to gain a deeper level of activity understanding than is otherwise available when using simple relatively ordered activity sequences. For example, an activity sequence 120 with a one-hour gap between two activities might be represented as [activity1, one hour time-preserving token, activity2]. In some embodiments, time-preserving tokens 302 are only defined for temporal gaps above a predetermined minimum threshold, such as a duration of 1 minute, 30 seconds, 5 minutes, etc. For example, an activity sequence 120 that includes logging in, checking a profile after 4 minutes, sending a message after an hour, and logging off 10 minutes later might be represented as [log in, view profile, one hour time-preserving token, log off] if the minimum threshold is set to 5 minutes.

FIG. 4 depicts an example positional encoding over continuous time to preserve timing between activities in accordance with one or more embodiments. As discussed previously, time encoder 106 can build a time-preserving encoding 110 from the activity data 102 and timing data 122. In some embodiments, the time-preserving encodings 110 are encoded as positional encodings over a continuous time space to preserve absolute timings between activities 304 in the activity data 102.

To illustrate, consider an example scenario in which possible activities 304 include log in 306, view profile 308, view page 310, view job 312, and send invite 314. In particular, instead of placing tokens (themselves representing activities as discussed previously) on a uniform grid, tokens of a token sequence 108 are placed on a continuous time grid where the spacing along the x-axis corresponds to actual time intervals between tokens. In some embodiments, embedding curves 402, for example, sine and cosine functions of various offsets and frequencies, are overlayed on the continuous time grid to be used to generate position embedding values that reflect these varying temporal distances, preserving both the order and actual time gaps between tokens (activities).

Time-preserving encodings 110 can be generated for any token in token sequence 108 by finding the positional embedding values (see y-axis) of the embedding curves 402 at the time corresponding to the respective token. For example, consider a token sequence 108 having the sequence [log in, view profile, view profile, log in, view page, view job, log in, send invite]. As shown in FIG. 4, a first time-preserving encoding 110 (labeled “a₁”) can be represented as a vector having the positional embedding values [0.95, 0.60, 0.70, 0.25] (note that the ordering of these values can be fixed if desired by assigning a specific ordering to the embedding curves 402, omitted for clarity only). As further shown in FIG. 4, a second time-preserving encoding 110 (labeled “a₂”) might have the positional embedding values [0.75, −0.20, 0.99, 0.55].

In some embodiments, the time-preserving encodings 110 for each token can be concatenated to the encoding (e.g., input embedding 204 of FIG. 2) of each respective token before being passed to the foundational GPT model 112 as discussed previously.

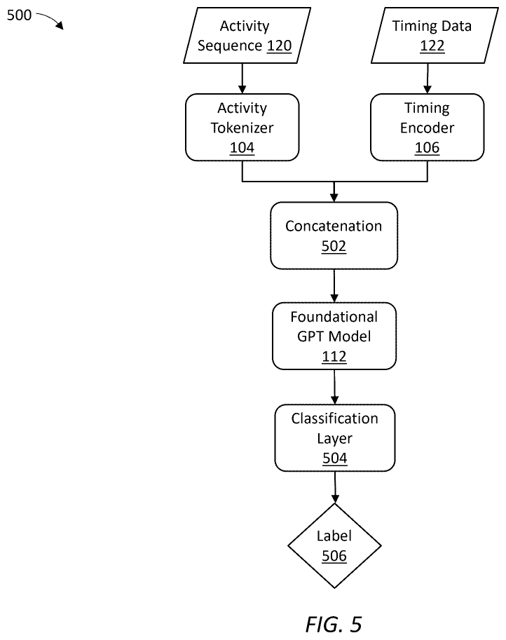

FIG. 5 depicts a block diagram of a process 500 for leveraging a foundational GPT model with time-preserving encodings at inference to generate labels in accordance with one or more embodiments. As shown in FIG. 5, the process 500 begins with the collection of an activity sequence 120 and corresponding timing data 122. The activity sequence 120, which consists of a chronological series of user actions, is processed by the activity tokenizer 104 to convert each activity into a token, thereby generating a token sequence 108. Simultaneously, or successively, the timing data 122, which captures the time intervals between activities, is processed by the timing encoder 106 to generate time-preserving encodings 110.

As further shown in FIG. 5, these tokenized activities and time-preserving encodings 110 are then combined through a concatenation step 502 to form a comprehensive input for the foundational GPT model 112. The foundational GPT model 112 processes this combined input to generate an output 114 that includes next activity predictions 116 and activity sequence embeddings 118 as discussed previously. In some embodiments, output 114 is further processed by a classification layer 504 to produce a final label 506, which can be used by secondary systems 124 for various applications, such as abuse detection, phishing detection, and more. In some embodiments, the combined input can be further supplemented with additional embedding types prior to inputting to the foundational GPT model 112. For example, this input can be supplemented with member embeddings that encode member attributes, such as a member's profile information, industry, job history, connections, etc. Member embeddings can serve as an additional signal for analyzing activities sequences (e.g., an individual taking many “view” actions against Company X members can be expected when that individual works or worked at Company X, but might be abnormal when the individual has no current or past affiliation with Company X, etc.).

In some embodiments, classification layer 504 includes one or more neural network layers that process the rich, timing-aware embeddings and predictions generated by the foundational GPT model 112 into actionable labels 506 that can be more readily used by secondary systems 124. In some embodiments, the classification layer 504 receives the universal activity embeddings 118 and next activity predictions 116 as input. In some embodiments, these inputs are high-dimensional vectors that capture the contextual and temporal relationships between user activities, as discussed previously. In some embodiments, the classification layer 504 applies various neural network operations, such as fully connected layers, activation functions, and dropout layers, to extract one or more features from the input embeddings. In some embodiments, the classification layer 504 uses the extracted features to make decisions about the nature of the input data. In some embodiments, this involves computing probabilities or scores for different classes or categories, such as “abusive behavior,” “normal behavior,” “phishing attempt,” etc. In some embodiments, this decision-making process is guided by a loss function, such as cross-entropy loss, which quantifies the difference between predicted and actual labels during training.

In some embodiments, the label 506 generated by the classification layer 504 is a categorical representation of the input data, indicating the predicted class or category. In some embodiments, the label 506 can be used by secondary systems 124 to take appropriate actions based on the nature of the input data. For example, the label 506 might indicate a “fake account”, an “account takeover”, or “normal behavior”. These labels 506 can be used, with or without further modification, by the secondary systems 124. For instance, an account labeled as “phishing account” might be flagged for further investigation by a dedicated secondary account 124 (e.g., the phishing model 128) to confirm the presence of phishing and, if necessary, to take corrective action. Similarly, an account labeled as “compromised account” might be flagged for further investigation by a dedicated secondary account 124 for confirming and handling compromised accounts (e.g., locking down accounts after confirmation and returning those accounts to their proper users).

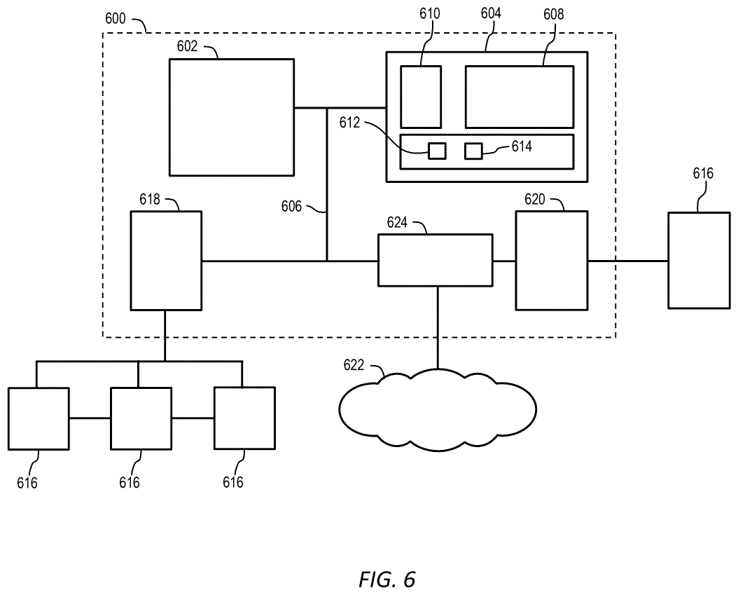

FIG. 6 illustrates aspects of an embodiment of a computer system 600 that can perform various aspects of embodiments described herein. In some embodiments, the computer system(s) 600 can implement and/or otherwise be incorporated within or in combination with the foundational GPT system 100 and/or secondary systems 124 described previously (refer to FIG. 1). In some embodiments, computer system 600 can be implemented server-side. For example, a remote computer system 600 can be configured to receive activity data 102, and in response, to generate output 114 including next activity predictions 116 and/or universal activity embeddings 118.

The computer system 600 includes at least one processing device 602, which generally includes one or more processors or processing units for performing a variety of functions, such as, for example, completing any portion of the foundational GPT system 100 described previously. Components of the computer system 600 also include a system memory 604, and a bus 606 that couples various system components including the system memory 604 to the processing device 602. The system memory 604 may include a variety of computer system readable media. Such media can be any available media that is accessible by the processing device 602, and includes both volatile and non-volatile media, and removable and non-removable media. For example, the system memory 604 includes a non-volatile memory 608 such as a hard drive, and may also include a volatile memory 610, such as random access memory (RAM) and/or cache memory. The computer system 600 can further include other removable/non-removable, volatile/non-volatile computer system storage media.

The system memory 604 can include at least one program product having a set (e.g., at least one) of program modules that are configured to carry out functions of the embodiments described herein. For example, the system memory 604 stores various program modules that generally carry out the functions and/or methodologies of embodiments described herein. A module or modules 612, 614 may be included to perform functions related to any of the block diagrams described herein. The computer system 600 is not so limited, as other modules may be included depending on the desired functionality of the computer system 600. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 602 can also be configured to communicate with one or more external devices 616 such as, for example, a keyboard, a pointing device, and/or any devices (e.g., a network card, a modem, etc.) that enable the processing device 602 to communicate with one or more other computing devices. Communication with various devices can occur via Input/Output (I/O) interfaces 618 and 620.

The processing device 602 may also communicate with one or more networks 622 such as a local area network (LAN), a general wide area network (WAN), a bus network and/or a public network (e.g., the Internet) via a network adapter 624. In some embodiments, the network adapter 624 is or includes an optical network adaptor for communication over an optical network. It should be understood that although not shown, other hardware and/or software components may be used in conjunction with the computer system 600. Examples include, but are not limited to, microcode, device drivers, redundant processing units, external disk drive arrays, RAID systems, and data archival storage systems, etc.

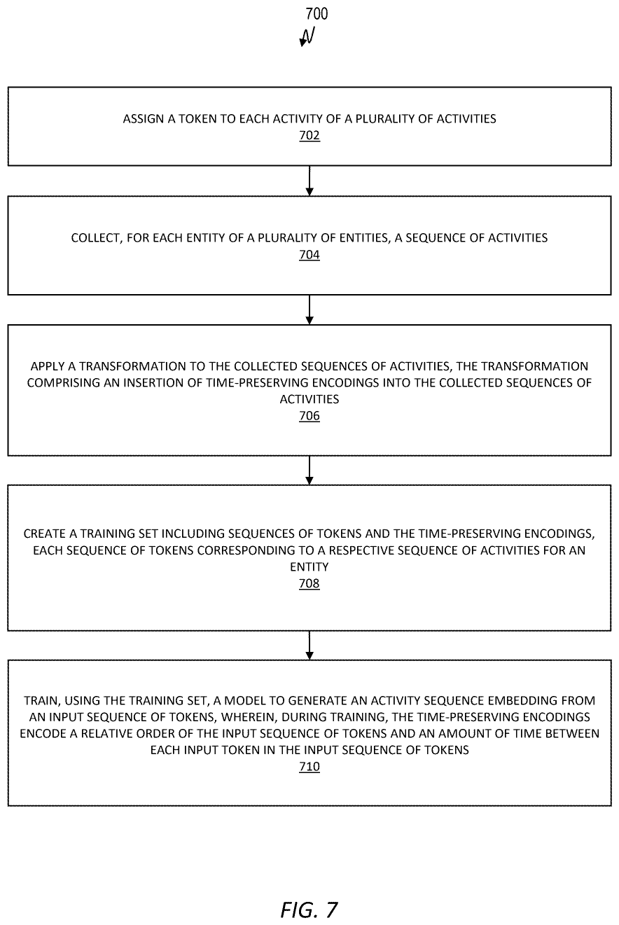

Referring now to FIG. 7, a flowchart 700 for leveraging a foundational generative pre-trained transformer (GPT) model with time-preserving encodings is generally shown according to an embodiment. The flowchart 700 is described with reference to FIGS. 1 to 6 and may include additional steps not depicted in FIG. 7. Although depicted in a particular order, the blocks depicted in FIG. 7 can be, in some embodiments, rearranged, subdivided, and/or combined.

At block 702, the method includes assigning a token to each activity of a plurality of activities.

At block 704, the method includes collecting, for each entity of a plurality of entities, a sequence of activities.

At block 706, the method includes applying a transformation to the collected sequences of activities. In some embodiments, the transformation includes an insertion of time-preserving encodings into the collected sequences of activities.

At block 708, the method includes creating a training set that includes sequences of tokens and the time-preserving encodings. In some embodiments, each sequence of tokens corresponds to a respective sequence of activities for an entity.

At block 710, the method includes training, using the training set, a model to generate an activity sequence embedding from an input sequence of tokens. In some embodiments, during training, the time-preserving encodings encode a relative order of the input sequence of tokens and an amount of time between each input token in the input sequence of tokens. In some embodiments, during training, the time-preserving encodings include a plurality of time-preserving tokens that are inserted among the input sequence of tokens, each time-preserving token encoding a predetermined time duration (refer to FIG. 3). In some embodiments, during training, the time-preserving encodings include positional embedding values derived from a continuous time space that are concatenated to tokens in the input sequence of tokens (refer to FIG. 4).

In some embodiments, the method includes, during an inference phase, receiving a first sequence of activities for a first entity. In some embodiments, the method includes generating, during the inference phase, a first sequence of tokens corresponding to the first sequence of activities by replacing each activity in the first sequence of activities with the respective token assigned to the activity. In some embodiments, the method includes inputting, during the inference phase, the first sequence of tokens to the foundational GPT model. In some embodiments, the method includes receiving, during the inference phase, an output from the foundational GPT model. The output can include a first activity embedding and a next activity prediction for the first sequence of activities.

In some embodiments, the method includes training a secondary system to generate malicious activity predictions from input activity embeddings. In some embodiments, the method includes inputting the first activity embedding to the secondary system. In some embodiments, the method includes generating, by the secondary system, a first malicious activity prediction.

In some embodiments, the malicious activity predictions include account abuse predictions, account phishing predictions, scrapping predictions, or fictitious account predictions.

In some embodiments, the method includes taking an enforcement action against an account of the first entity responsive to a value of the first malicious activity prediction being greater than a predetermined threshold.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or”unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
assigning a token to each activity of a plurality of activities;
collecting, for each entity of a plurality of entities, a sequence of activities;
applying a transformation to the collected sequences of activities, the transformation comprising an insertion of time-preserving encodings into the collected sequences of activities;
creating a training set comprising sequences of tokens and the time-preserving encodings, each sequence of tokens corresponding to a respective sequence of activities for an entity; and
training, using the training set, a model to generate an activity sequence embedding from an input sequence of tokens, wherein, during training, the time-preserving encodings encode a relative order of the input sequence of tokens and an amount of time between each input token in the input sequence of tokens.

2. The method of claim 1, wherein, during training, the time-preserving encodings comprise positional embedding values derived from a continuous time space that are concatenated to tokens in the input sequence of tokens.

3. The method of claim 1, wherein, during training, the time-preserving encodings comprise a plurality of time-preserving tokens that are inserted among the input sequence of tokens, each time-preserving token encoding a predetermined time duration.

4. The method of claim 1, further comprising:
during an inference phase, receiving a first sequence of activities for a first entity;
generating, during the inference phase, a first sequence of tokens corresponding to the first sequence of activities by replacing each activity in the first sequence of activities with the respective token assigned to the activity;
inputting, during the inference phase, the first sequence of tokens to the model; and
receiving, during the inference phase, an output from the model, the output comprising a first activity embedding for the first sequence of activities.

5. The method of claim 4, further comprising:
training a secondary system to generate malicious activity predictions from input activity embeddings;
inputting the first activity embedding to the secondary system; and
generating, by the secondary system, a first malicious activity prediction.

6. The method of claim 1, wherein each sequence of tokens is generated by replacing each activity in a respective sequence of activities with the respective token assigned to the activity.

7. The method of claim 6, wherein the model comprises a foundational generative pretrained transformer (GPT).

8. A system comprising a memory, computer readable instructions, and one or more circuitry for executing the computer readable instructions, the computer readable instructions controlling the one or more circuitry to perform operations comprising:
assign a token to each activity of a plurality of activities;
collect, for each entity of a plurality of entities, a sequence of activities;
apply a transformation to the collected sequences of activities, the transformation comprising an insertion of time-preserving encodings into the collected sequences of activities;
create a training set comprising sequences of tokens and the time-preserving encodings, each sequence of tokens corresponding to a respective sequence of activities for an entity; and
train, using the training set, a model to generate an activity sequence embedding from an input sequence of tokens, wherein, during training, the time-preserving encodings encode a relative order of the input sequence of tokens and an amount of time between each input token in the input sequence of tokens.

9. The system of claim 8, wherein, during training, the time-preserving encodings comprise positional embedding values derived from a continuous time space that are concatenated to tokens in the input sequence of tokens.

10. The system of claim 8, wherein, during training, the time-preserving encodings comprise a plurality of time-preserving tokens that are inserted among the input sequence of tokens, each time-preserving token encoding a predetermined time duration.

11. The system of claim 8, further comprising:
during an inference phase, receive a first sequence of activities for a first entity;
generate, during the inference phase, a first sequence of tokens corresponding to the first sequence of activities by replacing each activity in the first sequence of activities with the respective token assigned to the activity;
input, during the inference phase, the first sequence of tokens to the model; and
receive, during the inference phase, an output from the model, the output comprising a first activity embedding for the first sequence of activities.

12. The system of claim 11, further comprising:
train a secondary system to generate malicious activity predictions from input activity embeddings;
input the first activity embedding to the secondary system; and
generate, by the secondary system, a first malicious activity prediction.

13. The system of claim 8, wherein each sequence of tokens is generated by replacing each activity in a respective sequence of activities with the respective token assigned to the activity.

14. The system of claim 8, wherein the model comprises a foundational generative pretrained transformer (GPT).

15. A computer program product comprising a computer readable storage medium having program instructions embodied therewith, the program instructions executable by one or more circuitry to cause the one or more circuitry to perform operations comprising:
assign a token to each activity of a plurality of activities;
collect, for each entity of a plurality of entities, a sequence of activities;
apply a transformation to the collected sequences of activities, the transformation comprising an insertion of time-preserving encodings into the collected sequences of activities;
create a training set comprising sequences of tokens and the time-preserving encodings, each sequence of tokens corresponding to a respective sequence of activities for an entity; and
train, using the training set, a model to generate an activity sequence embedding from an input sequence of tokens, wherein, during training, the time-preserving encodings encode a relative order of the input sequence of tokens and an amount of time between each input token in the input sequence of tokens.

16. The computer program product of claim 15, wherein, during training, the time-preserving encodings comprise positional embedding values derived from a continuous time space that are concatenated to tokens in the input sequence of tokens.

17. The computer program product of claim 15, wherein, during training, the time-preserving encodings comprise a plurality of time-preserving tokens that are inserted among the input sequence of tokens, each time-preserving token encoding a predetermined time duration.

18. The computer program product of claim 15, further comprising:
during an inference phase, receive a first sequence of activities for a first entity;
generate, during the inference phase, a first sequence of tokens corresponding to the first sequence of activities by replacing each activity in the first sequence of activities with the respective token assigned to the activity;
input, during the inference phase, the first sequence of tokens to the model; and
receive, during the inference phase, an output from the model, the output comprising a first activity embedding for the first sequence of activities.

19. The computer program product of claim 18, further comprising:
train a secondary system to generate malicious activity predictions from input activity embeddings;
input the first activity embedding to the secondary system; and
generate, by the secondary system, a first malicious activity prediction.

20. The computer program product of claim 19, wherein each sequence of tokens is generated by replacing each activity in a respective sequence of activities with the respective token assigned to the activity.
